(19) United States
(12) Patent Application Publication
(10) Pub. No.: US 2008/0011900 A1
(43) Pub. Date: Jan. 17, 2008

(54) Apparatus and method to control the flight dynamics in a lighter-than-air airship

(75) Inventor: Javier Quintana, Weston, FL (US)

Correspondence Address: JAVIER QUINTANA, 1349 CAMELLIA CIRCLE, WESTON, FL, 33326, US

(73) Assignee: Javier Quintana, Weston, FL (US)

(21) Appl. No.: 11/778,107

(22) Filed: Jul. 16, 2007

Related U.S. Application Data
(60) Provisional application No. 60/807,485, filed on Jul. 15, 2006.

(51) Int. Cl. B64B 1/02

(52) U.S. Cl. 244/30

(57) ABSTRACT

An apparatus and method to control the attitude, heading course, altitude and position of a lighter-than-air airship. In one aspect, a hybrid airship including a lighter-than-air gas filled envelope, a thrust vectored front propulsion system, a back rotary wing system and a onboard control system. In one aspect, at least one system to modify the on board mass, a system to control the internal pressure, at least a power battery pack and a radio link communications for unmanned piloting. Said hybrid airship has improved maneuverability, safely flights and is capable to fly as Lighter-than-air airship and Heavy-than-air aircraft.

### BACKGROUND OF THE INVENTION

1. Field of Invention

The present invention relates to a hybrid airship with lighter-than-air buoyancy properties, rotary wing aerodynamic properties, flight computer controller system, mass transfer systems and radio communications for UAV operations.

2. Description of the Related Art

Conventional lighter-than-air or buoyant aircraft commonly referred to as “airships” still using the same control scheme for several decades with some technical and materials improvements. A vectored front propulsion system with ailerons and rudders on back combined with internal ballonets and ballast systems provide the attitude and position on air space of these airships. The well know Goodyear blimp use this control scheme successfully for many years.

The main limitation of the rudder and aileron surface control is the poor or null response in a static non aerodynamic condition. To produce useful horizontal of vertical (lift) force, an aerodynamic surface needs air moving dynamically thru the wing (or the wing needs move thru the air). Due the size of envelope to produce enough aerostatic lift, the size of these surfaces is enormous to get useful forces and compensate the proportional large momentum of these airships. In some situations, said surfaces produce undesirable forces due lateral winds. The weight increment on the tail side due said surfaces promotes pendulum oscillations.

Temperature and pressure changes resulting from different flight altitudes and varying atmospheric condition generally cause the lighter-than-air gas (typically helium) contained within the envelope of the airship to expand or contract, resulting in a constantly varying volume of helium. To maintain a internal gas pressure on operative range, conventional airships employ one or more inner ballonets. The ballonets are filled with outside air o deflated by release contained air compensating changes in helium volume and maintain hull pressure within operative limits

A lift up force greater than a weight down force produce an increment on airship altitude. A weight mass force greater than a lift up force reduce the airship altitude. Burn fuel, drop payload, humidity over envelope, rain and other factors change the static mass weight of airship. Lighter than air gas pressure changes and loss, change the static lift up force. In a conventional airship, the pilot have no way of actively manipulating the buoyancy of the airship other than releasing lighter-than-air gas into the atmosphere, releasing disposable ballast, or using the temporary main forward propeller to produce vectored thrust. Vertical take-off and landing are difficult to execute without buoyancy control.

Some prior art have reference to limitations of rudder and ailerons on airships, and show solutions using deflecting thrust propulsion or pivoting additional propellers on the desired direction. The main limitations of these prior arts are the inefficient deflected thrust, absence the systems to compensate changes on lift dynamic and residual thrust produced by directional propellers, obstructions on envelope for possible advertising messages, slow changes due mechanical limitations of deflected thrust or pivoting propellers producing temporary forces in undesirable directions triggering airship oscillations difficult to control without an active attitude pitch control or moving mass system.

Another limitation of conventional airships is the direct relation between the actuators and the pilot. A well trained pilot is necessary to understand the direct reaction forces using feedback instruments. Airships have enormous inertia momentum and pilot can be confused with delays of reaction forces.

Limitations on drop relative heavy payloads are not been considered in the majority of prior art. The problem to drop relative heavy payload from an airship is the abrupt change of buoyancy without any possibility to compensate quickly.

Many medium size airships are a downsize version of large airships like the famous Goodyear. The ratio size (inertia) vs. energy payload to produce power is very different on many actual medium size airships. This problem is easily visible when medium size blimps try to flight in outdoor spaces with oscillations only controllable if the airship always has an appreciable forward speed.

More Advantages:

To enhance the maneuverability of airships, the invention include a rotary wing system combined with the traditional vectored front propulsion, ballast, mass displacement and inner ballonets systems all linked with a flight computer controller to integrate the increment of complexity. The rotary wing produces active dynamic directional forces without wind or relative movement of airship into the air. This advantage combined with the capability to transfer mass produce a new set of dynamic capabilities like vertical take-off and landing, altitude and buoyancy control, attitude control, turns around itself, important additional fault-recovery procedures and redundant capability of critical active control elements like motors, engines, propellers, communications, actuators etc. between others.

The traditional control surfaces are removed to reduce weight, reduce undesirable forces due cross winds and increment the visible area when is used for advertising purposes.

The pilot experience and training requirements are reduced and permit a more relaxed flight with the pilot concentrate on a safety flight and the original flight plan.

A pitch control loop and the capacity to produce dynamic lift reduce oscillations; increment the cargo payload with the capability to drop more efficiently payload cargo with a faster compensation.

A more stable flight in hovering and close to hovering conditions produces a more elegant and smooth flight.

In another aspect:

The first purpose of this invention is to provide an attitude, altitude, heading and position control system for airships with redundant flight capabilities filled with a lighter-than air gas.

The second purpose of this invention is provide a method to compensate buoyancy variations due changes in atmospheric conditions (pressure, temperature), lighter-than air gas leaks, gas contamination, weight loss on burning fuel, dropping promotional or first aid materials and other factors.

The third purpose of this invention is to maximize the visible area of the airship envelope for advertising or public messages media display.

The fourth purpose of this invention is produce an easy and safe maneuverable airship using high level human commands.

The fifth purpose of this invention is to produce a refined and stable horizontal flight without pitch changes on the airship related to altitude changes.

The sixth purpose of this invention is to increase the cargo capacity and flight time.

Further objects and advantages of my invention will become apparent from a consideration of the drawings and ensuing description.

### SUMMARY

To achieve the foregoing and other objectives and in accordance with the purpose of the present invention, there is provided an improved method and apparatus for controlling the flight dynamics of an airship. According to a first aspect of the present invention, the hybrid airship includes a gas-containment envelope for lighter-than-air gas, a support structure, a least one rotary wing system located toward a tail end of said support structure, at least one front propulsion system located on the bottom side of said support structure and a flight computer controller system to achieve and maintain the flight dynamics of airship following pilot commands.

In another aspect of the present invention, a mass transfer system linked to said flight computer controller system to produce variations of altitude, heading and pitch dynamically.

In still another aspect of the present invention, the hybrid airship comprises a set of power batteries, onboard electricity generator and a radio link communications to ground pilot for unmanned operations.

### BRIEF DESCRIPTION OF THE DRAWINGS

FIG. 1 is a front perspective view of the first embodiment;

FIG. 2 is a front perspective view of the second embodiment;

FIG. 3a is a right view showing axis definitions;

FIG. 3b is a back view showing axis definitions;

FIG. 4 is a front perspective view of a portion of embodiments showing the front propulsion system pivoting about a horizontal axis;

FIG. 5 is a perspective view of an implementation of cylindrical rotary wing system;

FIG. 6a is a back view of cylindrical rotary wing showing the neutral thrust blade position;

FIG. 6b similar to FIG. 6a showing a substantial vertical thrust with an applied cyclic pitch;

FIG. 6c similar to FIG. 6a showing a substantial horizontal thrust with an applied cyclic pitch;

FIG. 7 is a perspective view of an implementation of disk rotary wing system with the semi-elliptical torsion shock absorber support;

FIG. 8 is a front view showing a simplified torsion control support for the disk rotary wing system;

FIG. 9a is a back view of the disk rotary wing showing a substantial vertical thrust with an applied collective pitch;

FIG. 9b similar to FIG. 9a showing a substantial horizontal thrust with an applied cyclic pitch;

FIG. 9c similar to FIG. 9a showing a vector thrust using torsion control on the disk rotary wing support and with an applied collective pitch;

FIG. 10 illustrates the center of mass components (CoM);

FIG. 11 illustrates the center of lift components (CoL);

FIG. 12 illustrates typical flight configurations and CoM and CoL vector relative values;

FIG. 13 is a simplified block diagram of the flight computer controller system;

FIG. 14 is a simplified block diagram of the airship status system;

FIG. 15 is a simplified block diagram of the front propulsion system;

FIG. 16 is a simplified block diagram of the rotary wing system;

FIG. 17 is a simplified block diagram of the fluid Ballast system;

FIG. 18 is a simplified block diagram of the air ballonet system;

FIG. 19 is a simplified block diagram of the mass displacement system;

FIG. 20 is a simplified block diagram of the generator system;

FIG. 21 is a simplified block diagram of the Communications system.

### DRAWINGS—REFERENCE NUMERALS

40. The buoyant gas container envelope;

41. Structure to attach all hybrid airship components to the envelope container;

44. Rear undercarriage structure;

45. Front undercarriage and front propeller support structure;

46. Structure to join the front propellers system and the rotary wing system;

52a. cylindrical rotary wing;

52b. disk rotary wing (rotorcraft, helicopter rotor);

53. Swash plate with cyclic and collective blade pitch control;

54. Rotary wing power source;

60. Rotary wings. (Airfoil blades);

61. Disk synchronizer Axle;

62. Cyclic pitch servos;

63. circular plates support;

64. Angle of attack (wing pitch) mechanics linked to swash plate;

68. Thrust vectors produced by the rotary wing;

69. Thrust vector net result;

70. Rotor axle disk rotary wing system;

72. Semi-elliptical rings, vibration absorber, support structure;

80. Front propulsion system;

82. Front propulsion system rotating axle;

91. Rear container;

92. Front container;

94. The rear inner ballonet;

95. The front inner ballonet;

97. Moveable battery packs and lineal low speed actuator;

100. Maximum angle L2 axis definition, parallel to an axis tangent to envelope shape;

101. Minimum angle L2 axis definition, parallel to longitudinal axis;

102. Vertical axis;

103. Longitudinal axis;

104. Horizontal axis;

110. Universal joint;

112. Double port hydraulic cylinder;

113. Control valve/cushion system;

114. Free flow hydraulic connection;

116. base plate;

117. rotary wing system plate;

### DETAILED DESCRIPTION OF THE INVENTION

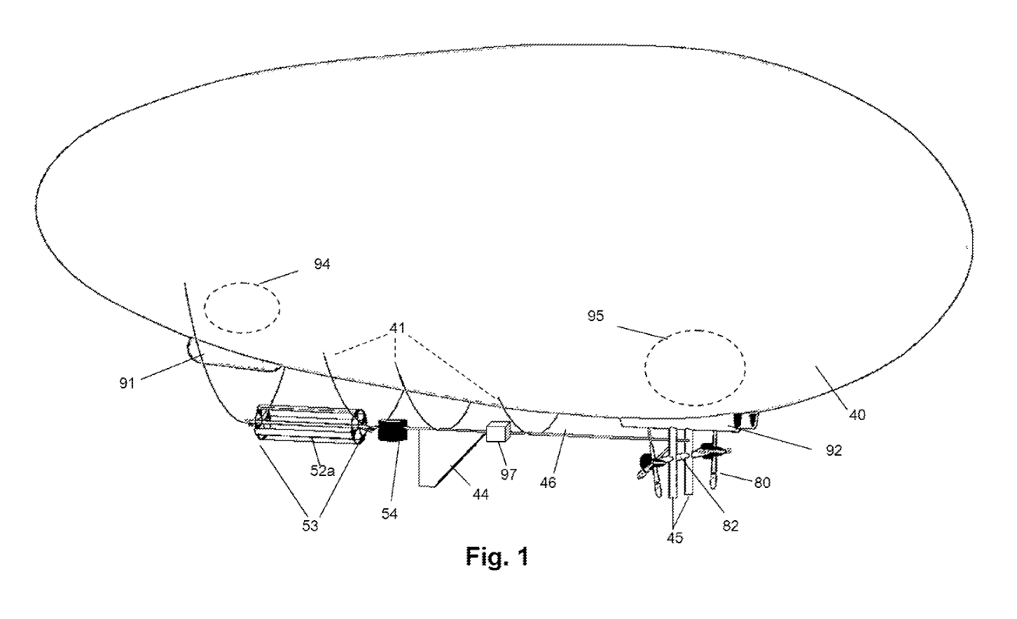

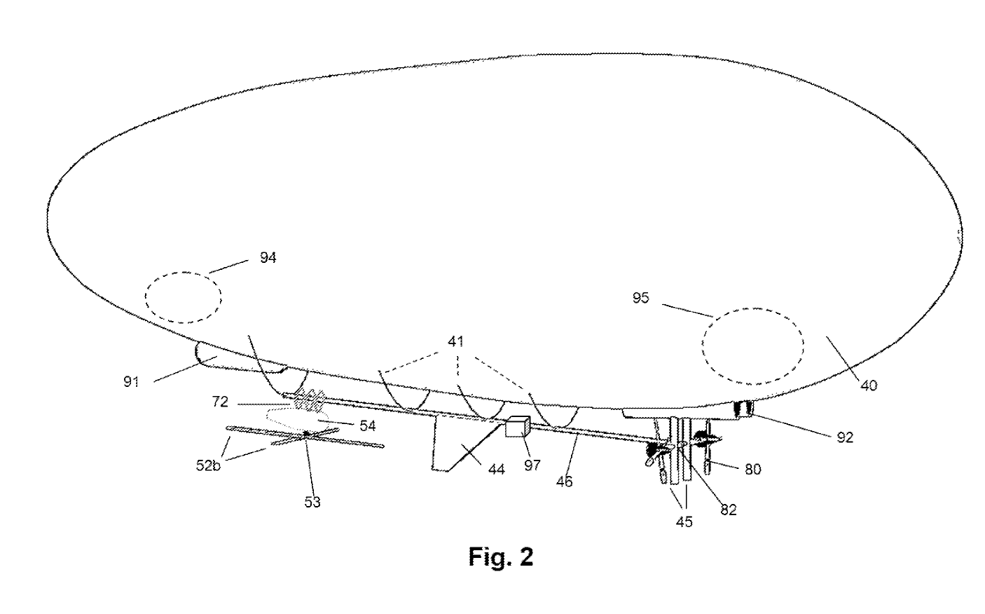

FIGS. 1 and FIG. 2 shows two embodiments of the present invention: a hybrid airship with improved capability to control the flight dynamics of a lighter-than-air airship. Said embodiments comprising an envelope 40 for containing the buoyancy lighter-than-air gas, a support structure to attach all components 41, 44, 45, 46, a rotary wing system 52a, 52b, a front propulsion system 80 and a rotating axle for said front propulsion system 82.

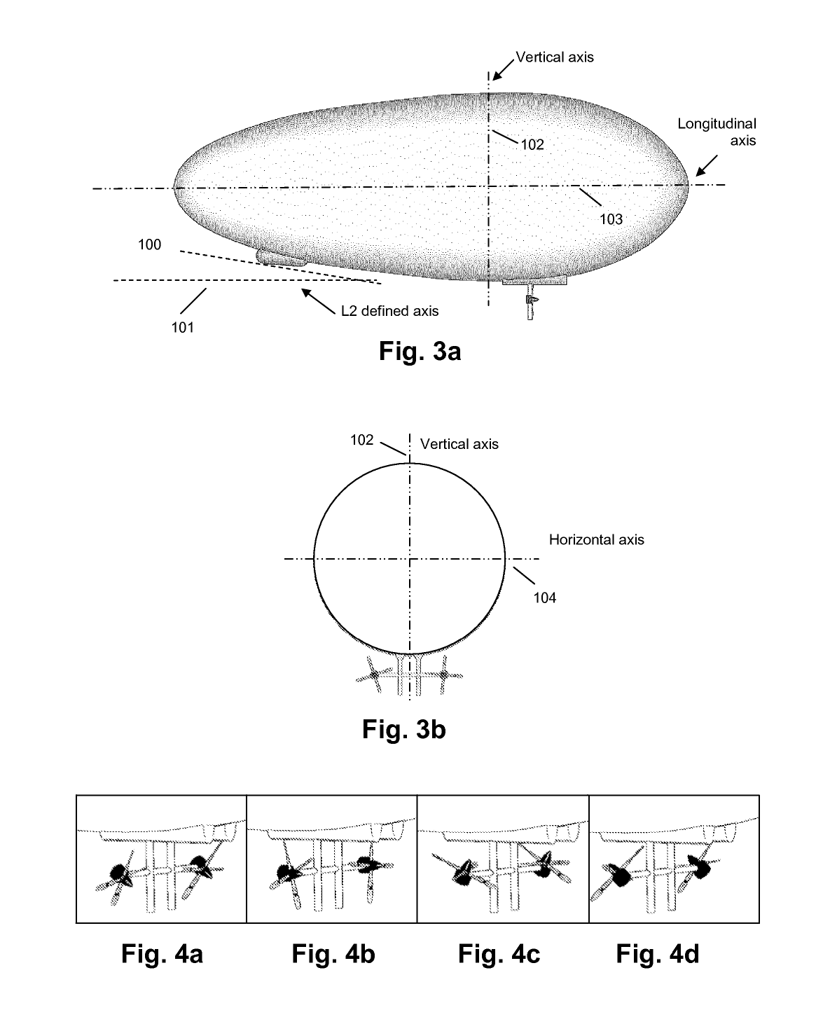

FIG. 3a, shows a L2 axis defined in a vertical plane having a longitudinal axis 103 and vertical axis 102. Said L2 axis have a predetermined angle with said longitudinal axis 103 between cero degrees 101 and the angle with a line tangent 100 to the envelope surface at the point of attachment of said rotary wing system.

All embodiments use said rotary wing system comprising a plurality of rotating wing airfoils 60 linked to a power source 54 coupled to a tail end of said support structure by a first connection, said first connection adapted to limit cushion movement of said rotary wing system. Said rotary wing system is positioned to generate directional thrust vectors substantially in a first vertical plane means orthogonal to said L2 axis, control of said directional thrust vectors means for variation of the angle of attack or pitch blade of each said wing airfoils independently and relative to the angle of rotation. Said wing airfoils have a pivot linked to a swash-plate 53 to permit angle of attack variations using collective said pitch blade and cyclic said pitch blade. Horizontal thrust vectors move the rear of the airship left and right to replacing conventional rudder surfaces. Vertical thrust vectors move the rear of the airship up and down replacing conventional elevator surfaces.

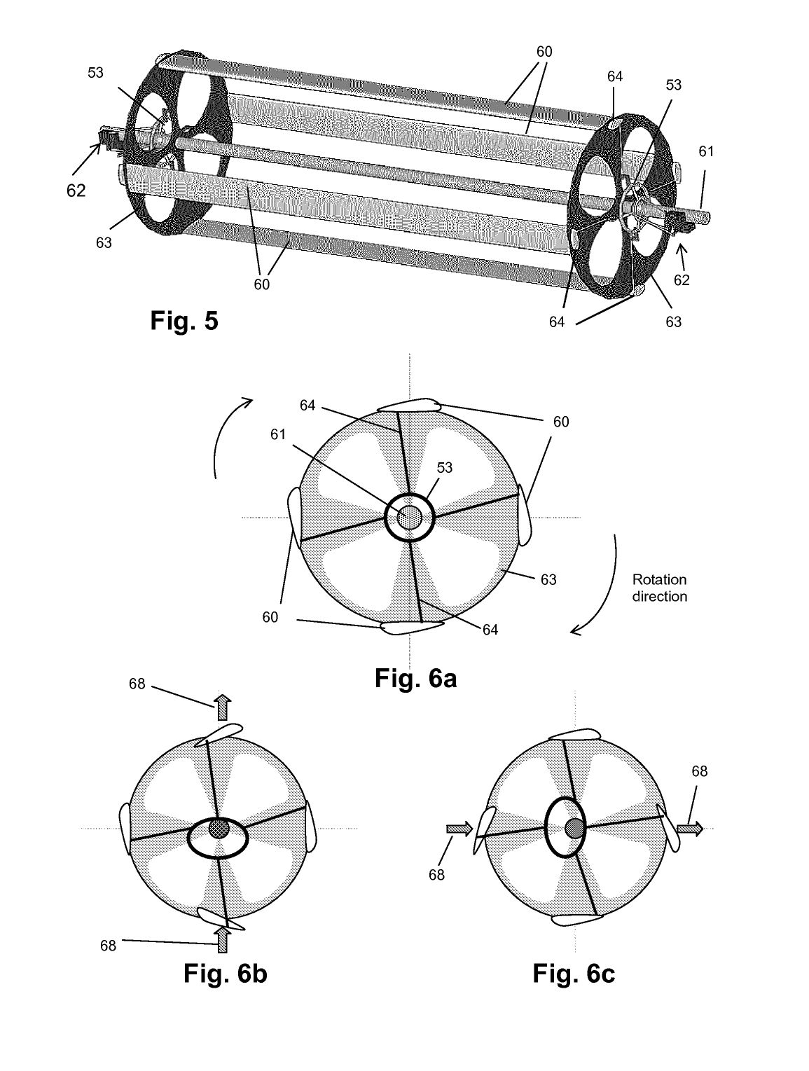

FIG. 1 shows a first embodiment using a cylindrical rotary wing system 52a similar to Voith-Schneider principle, common in work boats such as fireboats and tugboats. FIG. 5 shows a more detail of said cylindrical rotary wing system.

Said cylindrical rotary wing system or cycloidal rotor has a cylindrical array of said wing airfoils, said wing airfoils extend parallel to said L2 axis and attached to a rotating axis 61 parallel to said L2 axis, in both extremes with two lightweight circular plates 63. Said circular plates are synchronized means reducing torque tensions between said circular plates. A collective said pitch blade is possible but not useful on the cylindrical rotary wing system. FIGS. 6b, 6c shows said thrust vectors of said cylindrical rotary wing system. Said wing airfoils rotate at the same lineal speed in a circular flight path. The preferred angle for said L2 axis on said first embodiment but not limited to, is the minimum defined 101, equivalent to an axis parallel to said longitudinal axis. The preferred airfoil for said first embodiment but not limited to, is a full symmetrical cross-section airfoil.

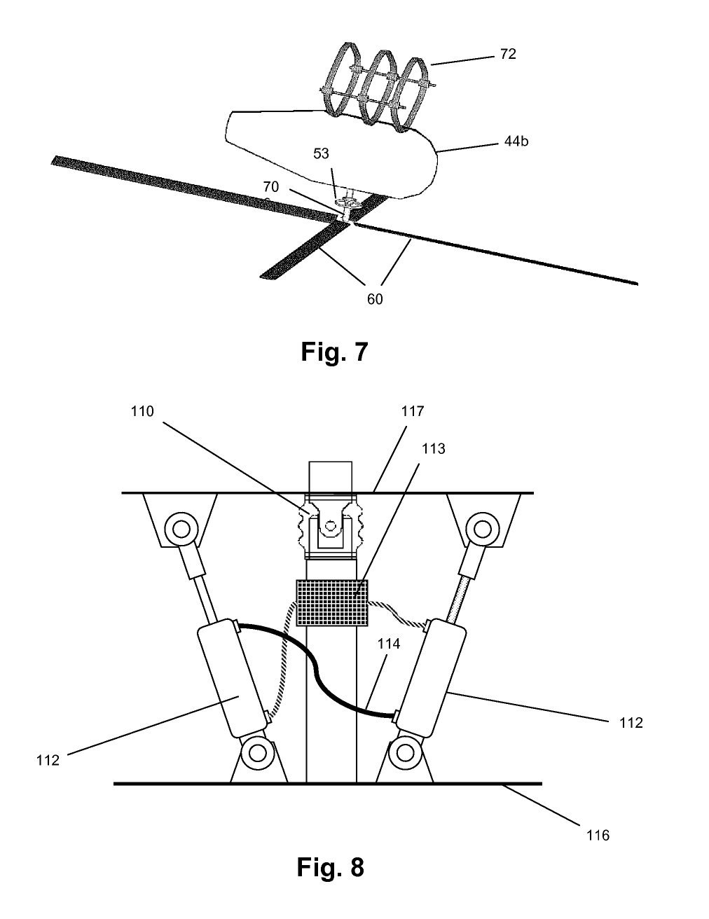

FIG. 2 shows a second embodiment using a disk rotary wing system 52b similar to the main rotor blades of helicopters. FIG. 7 shows a more detail of disk rotary wing system. Said disk rotary wing system or rotor disk, has a radial array of said wing airfoils extending from a main rotor axle shaft 70. Said wing airfoils are attached to said main rotor axle shaft in only one extreme and rotating in a plane parallel to L2 axis and orthogonal to said rotor axle shaft. Said wing airfoils rotate at the same angular speed with linear speed increasing by the radio of said wing airfoil. The preferred angle for said L2 axis on said second embodiment but not limited to, is the maximum defined 100, equivalent to an axis tangent to the shape of the envelope at the position of the rotary wing. The preferred airfoil for said second embodiment but not limited to, is a semi-symmetrical cross section airfoil.

Said disk rotary wing system is attached to a set of semi-elliptical rings 72 means capacity to absorb the characteristic vibration and means permit limited small movements around said L2 axis.

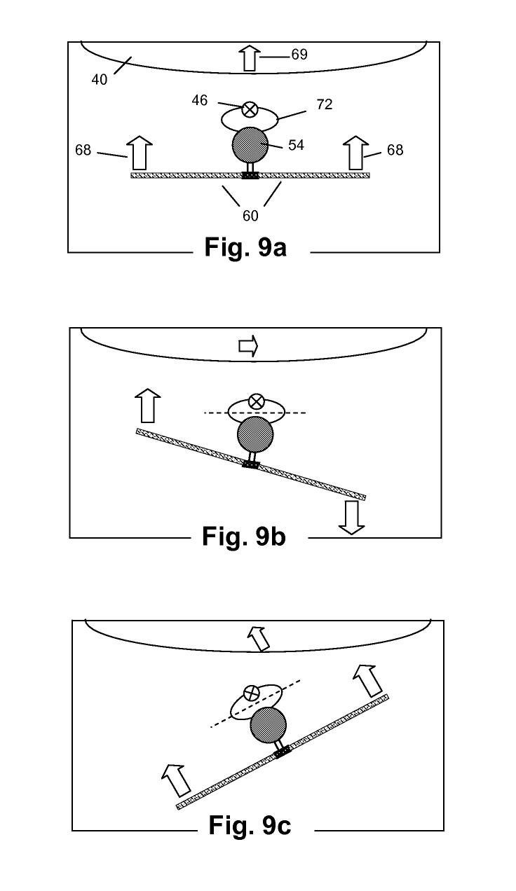

FIG. 9b shows a small torsion produced by cyclic said pitch blade. Said small torsion, means increasing the horizontal thrust useful to modify heading course.

FIG. 8 shows an alternative for said semi-elliptical rings. An elongate universal joint 110 attached to a base plate 116 in one end and attached to a rotary wing system plate 117 in the other end. Said rotary wing plate is attached to said rotary wing system and said base plate is attached to said support structure. A pair of hydraulic cylinders 112 are mounted on each axle of free movement of said universal joint and operatively connected with said base plate and said rotary wing system plate. A inlet port in one said hydraulic cylinder is operatively connected 114 to a outlet port of the associate said hydraulic cylinder axis pair. The remaining ports are operatively connected using a control valve 113. An alternative to said hydraulic control valve is using an active hydraulic cushion system with pump capability.

A third and fourth embodiment are similar to the first and second embodiment respectively with said rotary wing system located on the rear top of said envelope. A fifth and six embodiments are similar to first, second and third, fourth respectively when the rear position is the limit where top and bottom converge in the most rear part of said envelope.

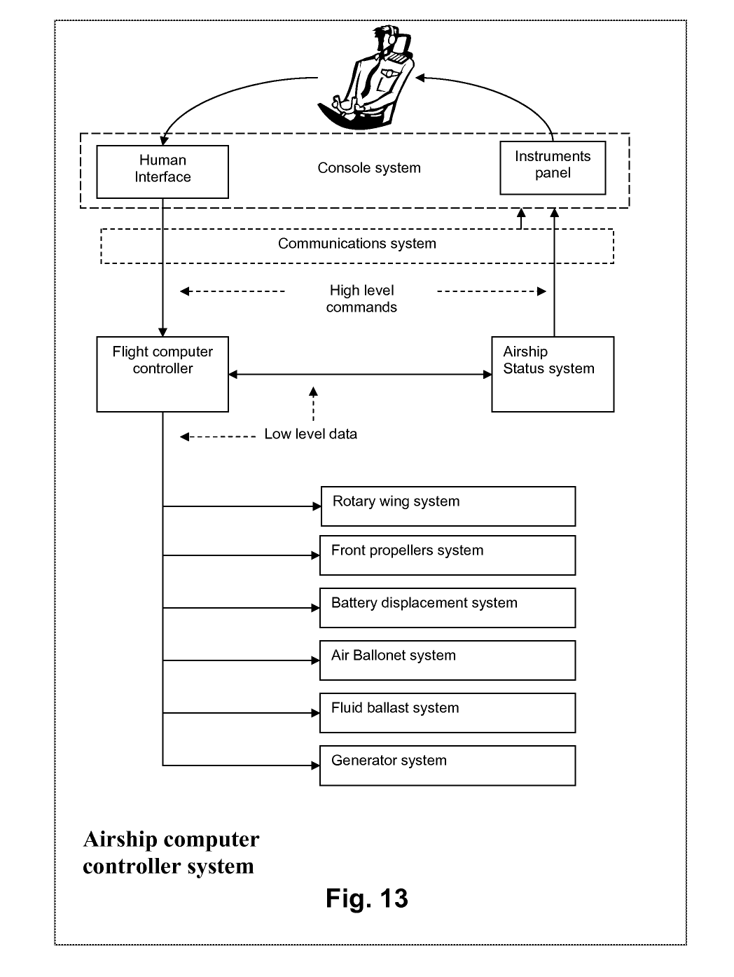

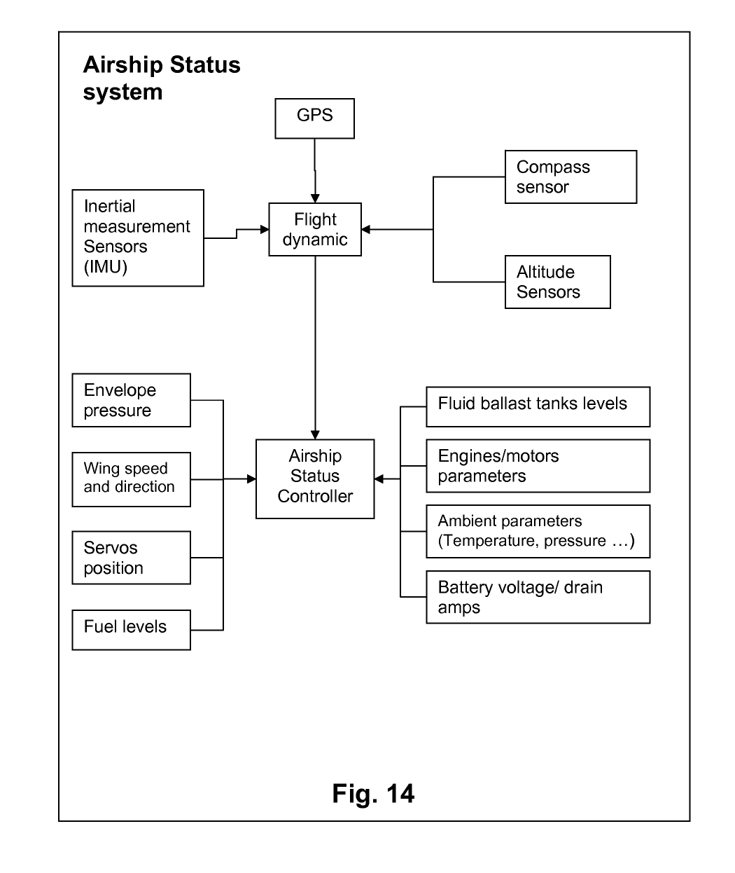

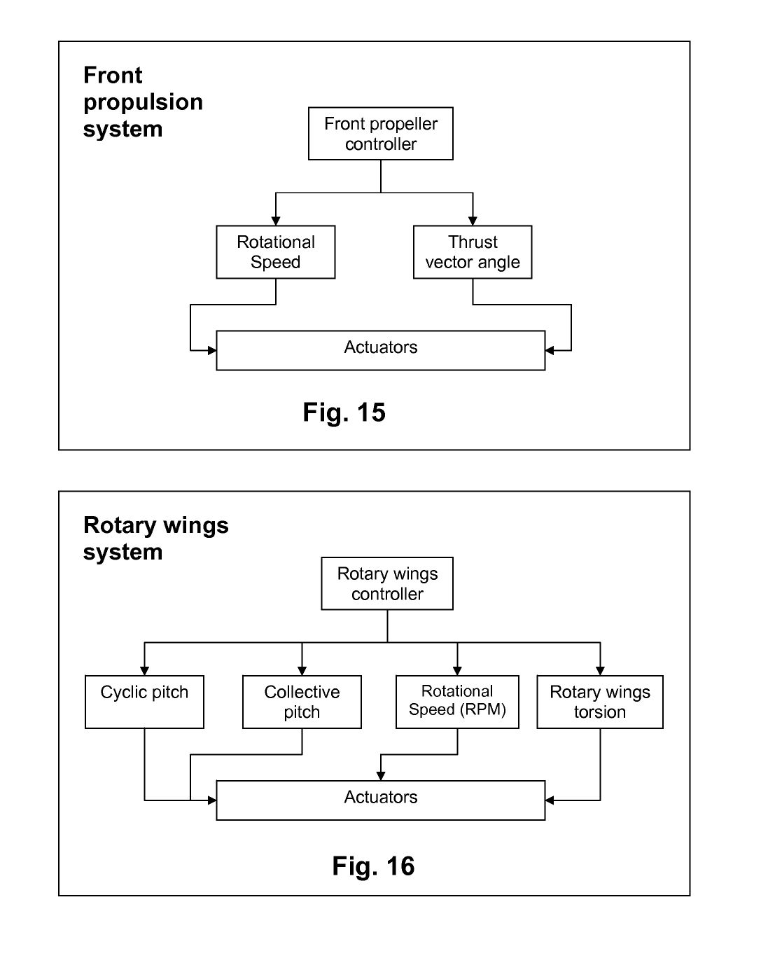

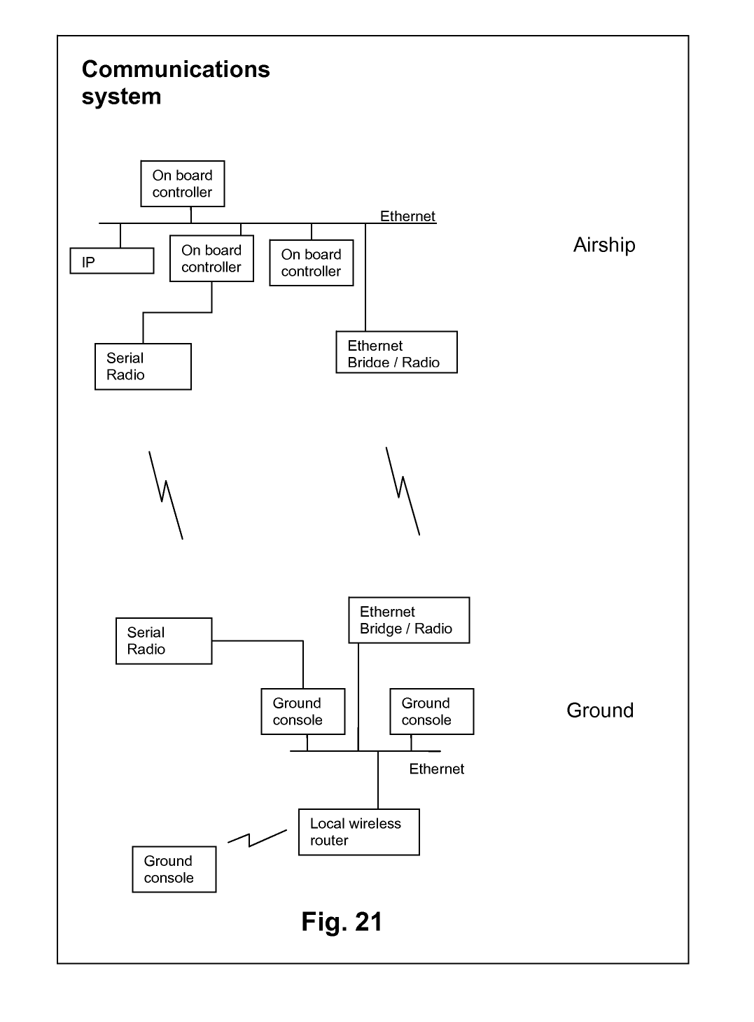

FIG. 13 shows a flight computer controller system. Said flight computer controller system receive flight parameters commands like, altitude, pitch angle setpoint, position on air relative to ground, heading course, flight speed and other similar high level human parameters in conjunction with data from an airship status system FIG. 14 to compute and produce usable data to move actuators and raw controllers. Said airship status system sends back to the pilot the necessary feedback information of airship operation and status. When the airship is an unmanned aerial vehicle or UAV, a radio link communications system FIG. 21 is used to operate the hybrid airship.

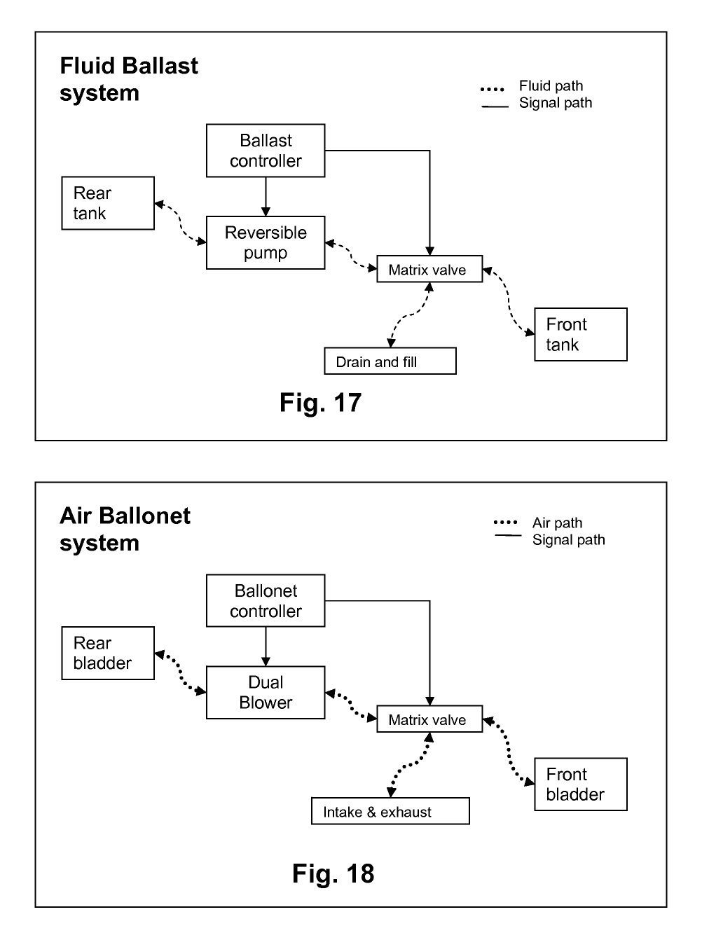

FIG. 17 shows a fluid ballast system comprising a rear tank, a front tank, a reversible fluid pump and a matrix valve with at least 2 bidirectional ports and one drain/fill port. A ballast controller move fluid from said rear tank to said front tank or vice versa using said reversible pump said matrix valve opening for free fluid transfer between tanks. Said ballast controller can release mass by draining the rear tank thru said pumping. The preferred fluid but not limited to, is regular water with the option of some substance diluted to increase the density without affecting the pumping speed considerably and produce harmful drop ballast.

FIG. 18 shows an air ballonet system similar to said fluid ballast system in operation using air instead fluid.

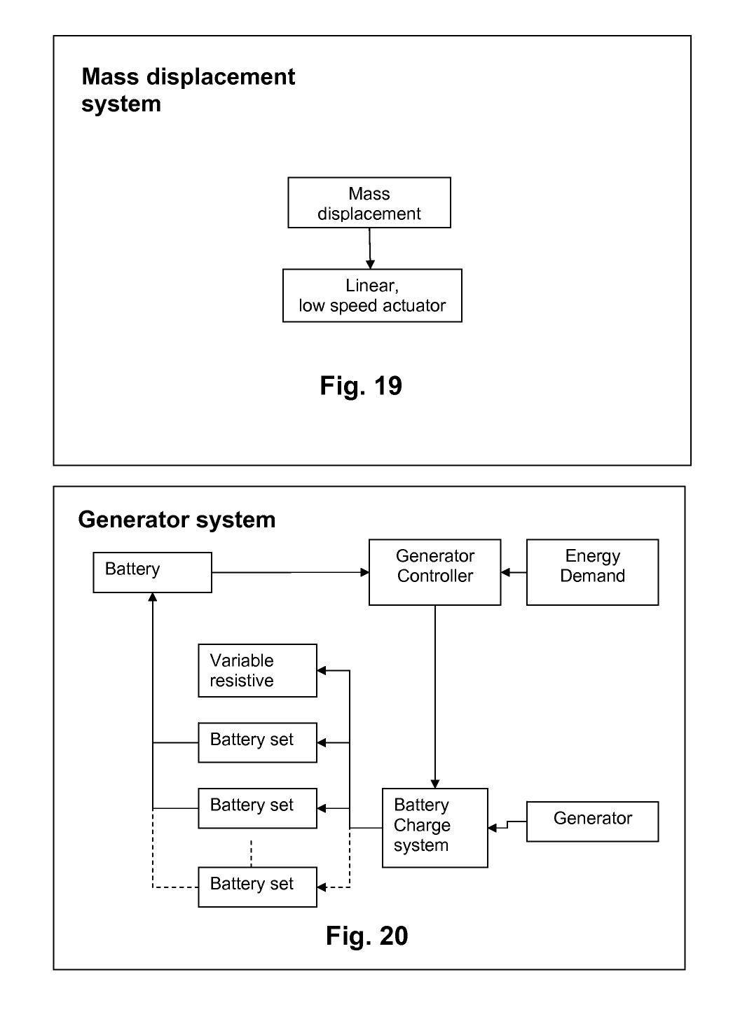

FIG. 19 shows a mass displacement system moving concentrate weight (battery packs) using a lineal low speed, actuator.

An onboard generator FIG. 20, charges the batteries. The autorotation phenomenon typical in rotating airfoil systems can be used to generate energy and charge batteries

Operation:

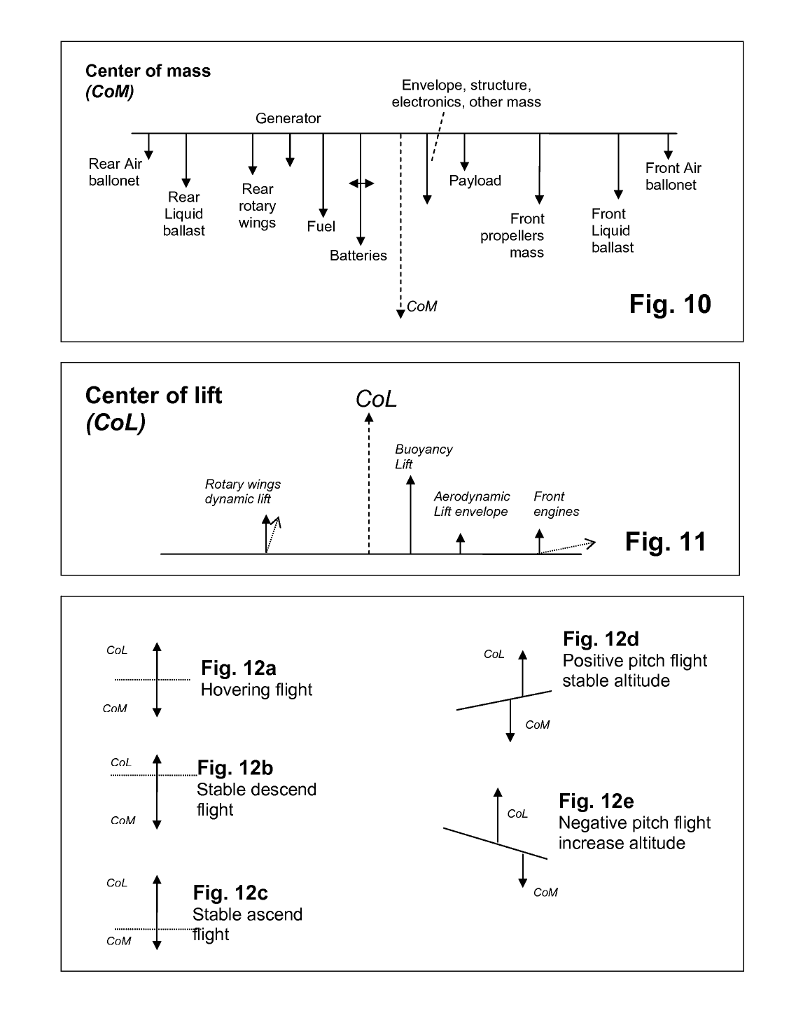

FIG. 10 shows the Center of Mass point CoM, said CoM is defined as the point where the sums of all weight vectors are equally balanced.

FIG. 11 shows the Center of Lift point or CoL, said CoL is defined as the point where the sum of all lift force vectors is equally balanced.

FIGS. 12a, 12b, 12c, 12d and 12e shows typical flight conditions. Controlling the vertical thrust vectors to produce changes on said center of lift (CoL) combined with the capacity of this invention to produce variations of said center of mass (CoM) in flight provide the ability to control the altitude easily and compensate buoyancy variations. A pitch control loop, an internal part of said flight computer controller system, generates the output to match said CoL with said CoM to produce a constant pitch attitude. Moving said CoM in direction to the front will decrease the net lift 12b without modified the pitch attitude. Moving said CoM in direction to the rear of said airship will increase the net lift 12c without modified the pitch attitude.

Pumping fluid ballast and/or fuel FIG. 17, inflating and deflating internal air ballonets FIG. 18 or moving mass back and forward FIG. 19 are the conventional methods to change said CoM in many airships, including aircraft and submarines.

Said fluid ballast system and said mass transfer system permit quick changes on said CoM. Said Fluid ballast system has the ability to drop out fluid to reduce the total weight of the airship when it is necessary. Said inner ballonets system has been used for long time in many airships. The additional benefit is maintaining constant the internal pressure of the envelope. Moving air back or forward between ballonets 94, 95 will change the CoM of the airship by displacement of differential density weight between gas/air. (Other valid point of view is the change of the CoL)

Moving said CoM close enough to said rotary wing system, will convert the airship from a lighter-than-air LTA to a heavy-than-air HTA airship, increasing the capacity to carry additional weight like supplementary fuel tanks, heavy displays, video and communications equipment, radars, etc.

FIG. 12a shows CoM equal in magnitude and position than CoL, producing stable flight without altitude or pitch attitude change, useful on cruise forward flight;

FIG. 12b FIG. 12c shows CoM different magnitude, equal position than CoL, producing changes on altitude without pitch attitude change, useful on vertical take-off and landing procedures;

FIG. 12d shows CoM equal in magnitude, different position than CoL, producing changes on attitude pitch without altitude change;

FIG. 12e shows CoM different magnitude and position than CoL, producing changes on altitude and attitude pitch;

FIG. 4 shows the front propulsion system having a pivot in a horizontal axis orthogonal to said longitudinal axis to permit thrust changes in a vertical plane parallel to said longitudinal axis, as usual in many airships.

The rear rotary wings and the front propellers are attached to the envelope and coupled between with a lightweight structure 46 to reduce stress on said envelope and to void oscillatory and resonant effects.

In an event of failure, a non working condition of said rotary wing system, said flight computer controller system move said CoM to reach the new said CoL, combine with the said thrust changes on front propulsion system the airship can perform a maneuver to land safely and fix the problem for the next flight.

In an event of failure, a non working condition of said front propulsion system, said flight computer controller system move said CoM to increase said hybrid airship attitude pitch angle to get residual forward thrust from said rotary wing system and perform a maneuver to land safely and fix the problem for the next flight.

In an event of failure, a non working condition of any mass transfer system, said fluid ballast system or said air ballonet system or said mass displacement system available system take in place to perform a maneuver to land safely and fix the problem for the next flight.

The invention is not limited but preferable, to an elongate shape envelope showed in all embodiments. A spherical, elliptical or any envelope shape can be used with this invention, when contain a lighter-than-air gas.

I claim:

1. A hybrid airship, comprising:
(a) a gas-containment envelope for lighter-than-air gas comprising an impermeable surface capable of retaining said gas with adequate strength to accept pressure and other leads;
(b) a support structure operatively connected to said gas-containment envelope, said support structure means for transferring the buoyant lift of said gas to said structure and capable of providing lift to said structure and defining a first longitudinal axis;
(c) a rotary wing system comprising a plurality of rotating wing airfoils linked to at least one first power source coupled to a tail end of said support structure by a first connection, said first connection adapted to limit cushion movement of said rotary wing system;
(d) said rotary wing system is positioned to generate directional thrust vectors substantially in a first vertical plane means orthogonal to said first longitudinal axis, said directional thrust vectors actuation means variation of the angle of attack of each said wing airfoils independently and relative to the angle of rotation;
(e) a propulsion system comprising at least one propeller linked to at least one second power source operatively coupled at a bottom side of said support structure by a second connection mounted by bearing and actuation means pivoting about a horizontal axis orthogonal to said first longitudinal axis and positioned to generate main thrust vectors substantially in a second vertical plane orthogonal to said first vertical plane;
(f) control means operatively connected with actuation means specified in (d) and (e) for adjusting said wing airfoils, said directional thrust vectors and said main thrust vectors means to provide rotary wing cyclic, rotary wing collective and propulsion vectored thrust control operatively connected to a flight controller system means providing altitude, attitude, heading and ground relative position;
whereby said hybrid airship has improved maneuverability and redundancy.

2. The hybrid airship of claim 1, wherein said gas-containment envelope having at least one internal compartment with means to vary the volume of said internal compartment by infusion or exclusion of quantities of the surrounding air changing the volume of said internal compartment and maintain a given pressure of said lighter-than-air gas enclosed on said gas-containment envelope.

3. The hybrid airship of claim 1, wherein said support structure having at least two external fluid containers positioned at a bottom side of said support structure with means to vary the fluid level of said fluid containers by transfer fluid between said fluid containers moving mass and adjusting the center of mass position of said hybrid airship.

4. The hybrid airship of claim 1, wherein said support structure having a plurality of battery set and a lineal actuator with means to vary the position of said battery power moving mass and adjusting the center of mass position of said hybrid airship.

5. The hybrid airship of claim 1, wherein said support structure having an electricity power generator.

6. The Hybrid airship of claim 1, wherein said control system having flight dynamic sensors means electronic signals related with flight physics properties.

7. The hybrid airship of claim 1, wherein said control system having a radio link transmitter and receiver.

8. A method to operate a hybrid airship, comprising:
(a) setting an altitude flight from changing the relation of dynamic lift produced by said rotary wing and dynamic weight of said hybrid airship;
(b) setting an altitude flight from changing the relation of dynamic lift produced by said propulsion system and dynamic weight of said hybrid airship;
(c) setting an altitude flight from releasing ballast fluid;
(d) setting an altitude flight from using dynamic lift produced by said rotary wing or said propulsion system;
(e) setting a pitch attitude flight from changing the relative position of center of lift and center of mass of said hybrid airship;
(f) setting a heading course flight from generating a horizontal thrust from said rotary wing system;
(g) setting a heading course flight from generating a horizontal thrust from said propulsion system;
(h) receiving from ground pilot flight parameters and translate to raw data useful for actuators and controllers
(i) transmitting to ground pilot a hybrid airship status to feedback flight parameters.
